(19) United States
(12) Patent Application Publication
(10) Pub. No.: US 2016/0214571 A1
(43) Pub. Date: Jul. 28, 2016

(54) VEHICLE DRIVING CONTROL

(71) Applicant: CloudCar, Inc., Mountain View, CA (US)

(72) Inventors: Konstantin Othmer, Los Altos, CA (US); Ajay Madhok, Los Altos, CA (US)

(21) Appl. No.: 14/606,727

(22) Filed: Jan. 27, 2015

(51) Int. Cl. B60R 25/20; B60R 25/24; H04W 76/02; B60R 25/01

(52) U.S. Cl. CPC B60R 25/209; B60R 25/01; B60R 25/246; H04W 76/02

(57) ABSTRACT

A method of controlling vehicle driving is described. The method may include detecting that a mobile device is paired with a proxy device associated with a vehicle. The method may additionally include generating an approval signal responsive to detecting that the mobile device is paired with the proxy device. The method may additionally include sending the approval signal to the proxy device. The approval signal may authorize the proxy device to send a secret code to the vehicle to activate one or more vehicle functions associated with the vehicle. The method may additionally include detecting that the vehicle is in a drive mode responsive to an activation of the one or more vehicle functions. The method may additionally include performing one or more driving control functions responsive to detecting that the vehicle is in the drive mode.

### FIELD

Some embodiments described herein generally relate to monitoring and controlling vehicle driving.

### BACKGROUND

Unless otherwise indicated herein, the materials described herein are not prior art to the claims in the present application and are not admitted to be prior art by inclusion in this section.

Parents of a teenager driver may feel anxious when the teenager driver starts to drive a vehicle. They may want to know where and how the teenager driver drives the vehicle and/or if the teenager driver has arrived at a destination safely. Existing technologies may fail to monitor and control the driving of the vehicle by the teenager driver. Additionally, usage of existing technologies may be bypassed easily. For example, even if an application is capable of detecting a location of the vehicle, the teenager driver may not run the application while he or she is driving the vehicle.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some example embodiments described herein generally relate to techniques for monitoring and controlling vehicle driving.

In an example embodiment, a method of controlling vehicle driving is described. The method may include detecting that a mobile device is paired with a proxy device associated with a vehicle. The method may additionally include generating an approval signal responsive to detecting that the mobile device is paired with the proxy device. The method may additionally include sending the approval signal to the proxy device. The approval signal may authorize the proxy device to send a secret code to the vehicle to activate one or more vehicle functions associated with the vehicle. The method may additionally include detecting that the vehicle is in a drive mode responsive to an activation of the one or more vehicle functions. The method may additionally include performing one or more driving control functions responsive to detecting that the vehicle is in the drive mode.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an example operating environment that includes a proxy device, a vehicle, and a mobile device configured to monitor and control vehicle driving;

FIG. 2 shows an example flow diagram of a method of communicating a secret code from a proxy device to a vehicle;

FIG. 3A shows an example flow diagram of a method of implementing one or more vehicle functions and safety control procedures in a vehicle responsive to receiving a secret code;

FIG. 3B shows an example flow diagram of a method of implementing one or more vehicle functions and safety control procedures in a vehicle responsive to receiving an escape code;

FIG. 4 shows an example flow diagram of a method of monitoring and controlling vehicle driving; and

FIG. 5 is a block diagram illustrating an example computing device that is arranged for monitoring and controlling vehicle driving.

### DETAILED DESCRIPTION OF SOME EXAMPLE EMBODIMENTS

Embodiments described herein generally relate to techniques for monitoring and controlling vehicle driving.

Some embodiments described herein may allow monitoring and controlling vehicle driving behaviors of a user using a proxy device associated with a vehicle. The proxy device may include an identity-based token generator that may generate a token (e.g., a secret code) for identifying the user associated with the proxy device. For example, the proxy device may include a keyless entry key fob that is capable of providing a secret code for identifying the user. The proxy device may allow the user to drive the vehicle under one or more driving controls.

The proxy device may send the secret code to the vehicle so that the vehicle may activate one or more vehicle functions for the driver responsive to receiving the secret code from the proxy device. For example, the vehicle may unlock a door or may start ignition for the driver responsive to receiving the secret code from the proxy device. In another example, the vehicle may allow the driver to use the proxy device to unlock the door or to start ignition of the vehicle. In some embodiments, if the vehicle does not receive the secret code from the proxy device, the proxy device (e.g., a keyless entry key fob) may not be used to unlock the door or to start ignition of the vehicle. Thus, the driver may not be allowed to drive the vehicle.

In some embodiments, the proxy device may receive an approval signal from a mobile device that is paired with the proxy device. The mobile device may be associated with the driver of the vehicle. For example, the mobile device may include a smart phone or a tablet owned by the driver. The approval signal may instruct the proxy device to send the secret code to the vehicle for activating one or more vehicle functions associated with the vehicle so that the driver may start to drive the vehicle. For example, the driver may launch a control application stored on the mobile device and may pair the proxy device with the mobile device using the control application. The mobile device may generate and send the approval signal to the proxy device, causing the proxy device to transmit the secret code to the vehicle for unlocking the door and/or starting ignition of the vehicle.

However, in some embodiments, if the proxy device is not paired with the mobile device, the mobile device may not send the approval signal to the proxy device and the proxy device may not send the secret code to the vehicle. As a result, the driver may not be allowed to drive the vehicle using the proxy device such as a keyless entry key fob.

Responsive to receiving the secret code from the proxy device, the vehicle may identify the driver based on the secret code. The vehicle may implement one or more safety control procedures configured for the driver while the vehicle is in a drive mode. Example safety control procedures may include activating a geo-fencing function, setting a speed limit under which the vehicle may be driven by the driver on a particular road, performing a blood alcohol content test, and any other control procedures to improve driving safety. Implementation of the geo-fencing function may include reporting geographic locations and/or speed updates related to the vehicle to a second user (e.g., a parent of a teenager driver), generating a notification and sending the notification to the second user if the vehicle exits or enters a particular geographic zone, and/or any other geo-location based control functions.

After the driver pairs the mobile device with the proxy device, the mobile device (or the control application stored on the mobile device) may be configured to monitor and control the driving of the vehicle. For example, the mobile device may receive vehicle data from the vehicle and may determine a safety score for the driver based on the vehicle data. The vehicle data may include a recorded speed of the vehicle on a road, a speed limit on the road, weather conditions on the road, traffic conditions on the road, sudden accelerations, panic braking, and/or any other data that may be used to infer safe or unsafe driving behaviors of the driver.

In another example, the mobile device (or, the control application stored on the mobile device) may perform one or more driving control functions to control driving behaviors of the driver while the vehicle is in a drive mode. Generally, the mobile device (or, the control application stored on the mobile device) may restrict usage of one or more device functions that may distract the driver from the driving task, such as restricting a texting function, a phone calling function, and a usage of one or more applications on the mobile device. Alternatively or additionally, the one or more driving control functions may include one or more safety control procedures that may be performed on the vehicle. For example, the mobile device (or, the control application stored on the mobile device) may generate and send one or more control commands to the vehicle, causing the vehicle to implement one or more safety control procedures.

In some embodiments, the mobile device (or, the control application stored on the mobile device) and/or the vehicle may provide pro-active notifications related to the driver's operations of the vehicle to another user that is interested in the driver's operations of the vehicle. The pro-active notifications may include location updates, speed updates, traffic updates, and any other information related to the driver's operations of the vehicle.

Alternatively or additionally, the mobile device (or, the control application stored on the mobile device) and/or the vehicle may provide driving suggestions to the driver. For example, if the driver is currently driving with a speed over a speed limit on a road, the mobile device and/or the vehicle may play a voice message to advise the driver to slow down. In another example, the mobile device and/or the vehicle may suggest that the driver accelerate gradually to avoid sudden accelerations. In yet another example, the mobile device and/or the vehicle may suggest that the driver slow down since there is a stop sign 10 meters (or some other distance) ahead of the road. The mobile device and/or the vehicle may provide other example suggestions to improve the driver's driving experience and/or driving safety.

An example usage of the technologies described herein may include monitoring and controlling vehicle driving behaviors of a new driver such as a teenager driver. The teenager driver may use a proxy device such as a keyless entry key fob to operate the vehicle. The teenager driver may pair the keyless entry key fob with a smart phone, causing the smart phone to send an approval signal to the keyless entry key fob. The approval signal may allow the teenager driver to drive the vehicle and may instruct the keyless entry key fob to send a secret code to the vehicle. The vehicle may use the secret code received from the keyless entry key fob to identify the teenager driver. The vehicle may activate one or more vehicle functions for the teenager driver so that the teenager driver may start to drive the vehicle. The vehicle may implement one or more driving control functions configured for the teenager driver. Alternatively or additionally, the smart phone may implement one or more driving control functions configured for the teenager driver.

The technologies described herein may provide pro-active help, driving feedback, a safety score, driving recommendations, and any other information or suggestions to the teenager driver to improve the teenager driver's driving experience. The technologies may also provide pro-active notifications (e.g., geo-fencing notifications), the safety score, safety alerts related to the teenager driver's operations of the vehicle, and any other information related to the teenager driver's operations of the vehicle to a parent of the teenager driver in real time or near real time. The technologies described herein may also provide the vehicle driving data to insurance companies, car companies, and/or other entities for performing usage analytics or making marketing strategies.

Other example usages of the technologies described herein may include unlocking a lock using a proxy device that is paired with a mobile device, applications with out-of-band authentication of a user, and any other suitable applications with a proxy device. An out-of-band authentication may include a user authentication process over a network or a channel separate from a primary network or a primary channel.

Reference will now be made to the drawings to describe various aspects of some example embodiments of the invention. The drawings are diagrammatic and schematic representations of such example embodiments, and are not limiting of the present invention, nor are they necessarily drawn to scale.

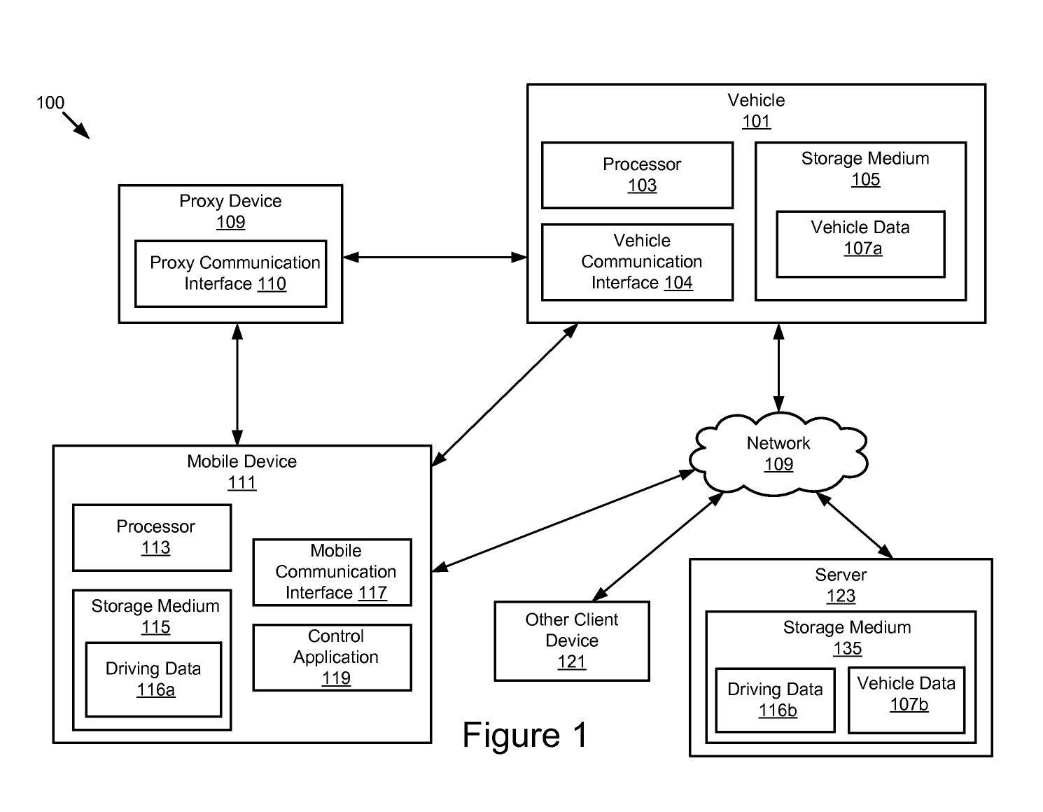

FIG. 1 is a block diagram of an example operating environment 100 that includes a vehicle 101, a proxy device 109, and a mobile device 111, arranged in accordance with at least some embodiments described herein. The vehicle 101, the proxy device 109, and the mobile device 111 may cooperate with each other to monitor and control the driving of the vehicle 101. Although one vehicle 101, one proxy device 109, and one mobile device 111 are illustrated in FIG. 1, the operating environment 100 may more generally include one or more vehicles 101, one or more proxy devices 109, and one or more mobile devices 111. In these and other embodiments, the operating environment 100 may include other servers and/or devices not shown in FIG. 1, such as a map server for providing a map service to the vehicle 101 and a weather server for providing weather information.

The operating environment 100 may additionally include another client device 121, a server 123, and a network 109. In general, the network 109 may include one or more wide area networks (WANs) and/or local area networks (LANs) that enable the vehicle 101, the mobile device 111, the other client device 121, and the server 123 to communicate with each other. In some embodiments, the network 109 may include the Internet, including a global internetwork formed by logical and physical connections between multiple WANs and/or LANs. Alternately or additionally, the network 109 may include one or more cellular radio frequency (RF) networks and/or one or more wired and/or wireless networks such as, but not limited to, 802.xx networks, Bluetooth access points, wireless access points, Internet Protocol (IP)-based networks, or the like. For example, the network 109 may include a mobile data network such as third-generation (3G), fourth-generation (4G), long-term evolution (LTE), Voice-over-LTE (VoLTE), or any other mobile data network or combination of mobile data networks. In some embodiments, the network 109 may include a global positioning system (GPS) satellite for providing GPS navigation to the mobile device 111 and/or the vehicle 101. The network 109 may also include servers that enable one type of network to interface with another type of network.

In general, the vehicle 101 may include an automobile or any other type of vehicle. The vehicle 101 may include a processor 103, a storage medium 105, and a vehicle communication interface 104. The processor 103 may be of any type including, but not limited to, a central processing unit (CPU), a microprocessor (μP), a microcontroller (μC), a digital signal processor (DSP), or any combination thereof. The processor 103 may be configured to execute computer instructions that, when executed, cause the processor 103 to perform or control performance of one or more of the operations described herein with respect to the vehicle 101.

The storage medium 105 may include volatile memory such as random access memory (RAM), persistent or non-volatile storage including, but not limited to, read only memory (ROM), electrically erasable and programmable ROM (EEPROM), compact disc-ROM (CD-ROM) or other optical disk storage, magnetic disk storage or other magnetic storage device, NAND flash memory or other solid state storage device, or other persistent or non-volatile computer storage medium. The storage medium 105 may store computer instructions that may be executed by the processor 103 to perform or control performance of one or more of the operations described herein with respect to the vehicle 101.

The storage medium 105 may additionally store vehicle data 107a associated with the vehicle 101. In some embodiments, the vehicle data 107a may include journey data that describes journeys associated with the vehicle 101. For example, the vehicle data 107a may include a start point, a destination, a route, a time of departure, a time of arrival, a travel distance, and any other data related to a journey. Alternatively or additionally, the vehicle data 107a may include data that describes how a driver drives the vehicle 101. For example, the vehicle data 107a may include: a recorded travel speed, a speed limit, deviations in travel speed above (or below) the speed limit along one or more portions of the route, traffic conditions, road construction information, and weather conditions along a route; sudden accelerations; panic braking; and any other data that may be analyzed to infer safe or unsafe driving behaviors. In these and other embodiments, the vehicle data 107a may include any other data related to the driving of the vehicle 101.

The vehicle communication interface 104 may provide any suitable form of communication capability between the vehicle 101 and one or more of the proxy device 109, the mobile device 111, and the network 109. For example, the vehicle communication interface 104 may include a wireless-fidelity (Wi-Fi) card for providing Wi-Fi connectivity. By way of example and not limitation, the vehicle communication interface 104 may be configured to provide, via wireless mechanisms, LAN connectivity, Bluetooth connectivity, Wi-Fi connectivity, near field communication (NFC) connectivity, Machine-to-Machine (M2M) connectivity, Device-to-Device (D2D) connectivity, any other suitable communication capability, or any suitable combination thereof. In these and other embodiments, the vehicle communication interface 104 may provide direct connectivity between the vehicle 101 and one or more of the proxy device 109 and the mobile device 111. In some embodiments, the vehicle communication interface 104 may include a transmitter and/or a receiver for providing any suitable form of communication capability described herein.

The mobile device 111 may include a mobile computing device that includes a processor 113, a storage medium 115, a mobile communication interface 117, and a control application 119. For example, the mobile device 111 may include a laptop computer, a tablet computer, a mobile telephone, a personal digital assistant (“PDA”), a mobile e-mail device, a portable game player, a portable music player, or another mobile electronic device with a processor and a memory. The mobile device 111 may be associated with the driver of the vehicle 101. For example, the mobile device 111 may include the driver's mobile phone, tablet or other mobile device.

Similar to the processor 103 of the vehicle 101, the processor 113 may be of any type including, but not limited to, a CPU, a μP, a μC, a DSP, or any combination thereof. The processor 113 may be configured to execute computer instructions that, when executed, cause the processor 113 to perform or control performance of one or more of the operations described herein with respect to the mobile device 111.

Similar to the storage medium 105 of the vehicle 101, the storage medium 115 may include volatile memory such as RAM, persistent or non-volatile storage including, but not limited to, ROM, EEPROM, CD-ROM or other optical disk storage, magnetic disk storage or other magnetic storage device, NAND flash memory or other solid state storage device, or other persistent or non-volatile computer storage medium. The storage medium 115 may store computer instructions that may be executed by the processor 113 to perform one or more of the operations described herein with respect to the mobile device 111.

In some embodiments, the storage medium 115 may store driving data 116a. The driving data 116a may include data that describes one or more driving behaviors of a user associated with the vehicle 101. For example, the driving data 116a may include data that describes how a teenager driver drives the vehicle 101. In some embodiments, the driving data 116a may include a safety score determined for the user. A safety score may describe how safely the user drives the vehicle 101. For example, compared to a low safety score, a high safety score may indicate that the user drives the vehicle 101 more safely.

The mobile communication interface 117 may provide any suitable form of communication capability between the mobile device 111 and one or more of the vehicle 101, the proxy device 109, and the network 109. For example, the mobile communication interface 117 may include a Wi-Fi card for providing Wi-Fi connectivity. By way of example and not limitation, the mobile communication interface 117 may be configured to provide, via wireless mechanisms, LAN connectivity, Bluetooth connectivity, Wi-Fi connectivity, NFC connectivity, M2M connectivity, D2D connectivity, any other suitable communication capability, or any suitable combination thereof. In these and other embodiments, the mobile communication interface 117 may provide direct connectivity between the mobile device 111 and one or more of the vehicle 101 and the proxy device 109. In some embodiments, the mobile communication interface 117 may include a transmitter and/or a receiver for providing any suitable form of communication capability described herein.

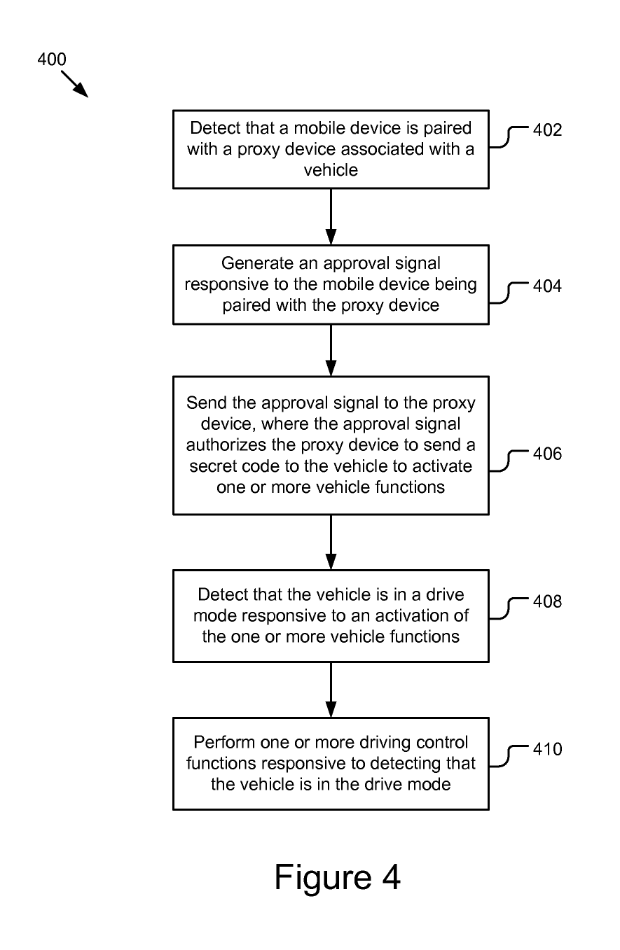

The control application 119 may monitor and/or control the driving of the vehicle 101. In some embodiments, the control application 119 may be implemented using hardware that includes a field-programmable gate array (FPGA) or an application-specific integrated circuit (ASIC). In some other embodiments, the control application 119 may include code and routines that, in response to execution by the processor 113, monitors and controls the driving of the vehicle 101. The control application 119 may be stored on the storage medium 115. Alternatively, the control application 119 may be implemented using a combination of hardware and software. In some embodiments, the control application 119 may be stored in a combination of the devices and servers, or in one of the devices or servers. The control application 119 may be configured to perform, e.g., operations described below with reference to FIG. 4.

The proxy device 109 may act as a proxy for a user associated with the vehicle 101. For example, the proxy device 109 may include a keyless entry device (e.g., a keyless entry key fob) associated with the vehicle 101. Alternatively, the proxy device 109 may include a mobile device, a smart wearable device, or any other device that may act as a proxy for the user associated with the vehicle 101. Example smart wearable devices may include a smart watch, a fitness monitoring band, a smart glass, smart eyeglasses, and/or any other wearable device that includes a processor and a memory.

In some embodiments, the proxy device 109 may include a token generator that may generate a token for identifying the user associated with the vehicle 101. The token may include a secret code used to identify the user and to activate one or more vehicle functions in the vehicle. For example, the proxy device 109 may send the secret code to the vehicle 101 so that the vehicle 101 may use the secret code to identify a driver that owns the proxy device 109, to unlock a door of the vehicle 101, and/or to activate ignition of the vehicle 101.

Example vehicle functions may include unlocking a door of the vehicle 101 automatically, enabling the user to use the proxy device 109 to unlock the door, activating ignition of the vehicle 101 automatically, enabling the user to use the proxy device 101 to activate ignition of the vehicle 101, starting an engine or an electric motor of the vehicle 101 automatically, enabling the user to use the proxy device 101 to start the engine or the electric motor of the vehicle 101, and/or any other vehicle functions related to the vehicle 101.

Additionally or alternatively, the secret code may be used to request the vehicle 101 to enforce one or more driving control functions configured for the user while the vehicle 101 is in a drive mode. For example, responsive to receiving the secret code, the vehicle 101 may identify the user as a teenager driver and may activate one or more driving control functions configured for the teenager driver. In general, the driving control functions may be enforced on one or both of the vehicle 101 and the mobile device 111.

Example driving control functions may include restricting usage of one or more device functions on the mobile device 111 (e.g., restricting a texting function, a phone calling function, and/or a usage of one or more applications on the mobile device 111), implementing one or more safety control procedures in the vehicle 101, determining a safety score for the user, and/or any other control functions that may be used to monitor and/or control driving behavior of the user. The one or more safety control procedures may include performing a geo-fencing function for the vehicle 101 (e.g., reporting geographic location updates of the vehicle 101, generating and sending a notification to another user if the vehicle 101 exits or enters a particular geographic zone), setting a speed limit under which the vehicle 101 may be driven by the user, performing a blood alcohol content test, and/or any other control procedures to improve driving safety.

In some embodiments, the user may pair the proxy device 109 with the mobile device 111 so that the mobile device 111 may monitor the user's driving behavior. The proxy device 109 may send the secret code to the vehicle 101 responsive to determining that the proxy device 109 is paired with the mobile device 111. However, if the proxy device 109 is not paired with the mobile device 111, the proxy device 109 may not send the secret code to the vehicle 101. As a result, the vehicle 101 may not activate the one or more vehicle functions for the user. The user may not be allowed to drive the vehicle 101 if the proxy device 109 is not paired with the mobile device 111.

The proxy device 109 may send a sound alarm code to the vehicle 101 if the proxy device 109 is in proximity to the vehicle 101 and is not paired with the mobile device 111. Alternatively, the proxy device 109 may send the sound alarm code to the vehicle 101 if the user tries to use the proxy device 109 to operate the vehicle 101 without pairing the proxy device 109 with the mobile device 109. The sound alarm code may trigger an alarm in the vehicle 101. The alarm may be switched off if the proxy device 109 is paired with the mobile device 111 and sends the secret code to the vehicle 101. Alternatively, the alarm may be switched off if the vehicle 101 receives an escape code from the proxy device 109.

In some embodiments, the proxy device 111 may include a built-in escape routine that may be triggered by the user so that the user may operate the vehicle 101 without pairing the proxy device 109 with the mobile device 111. For example, in some scenarios the user may not have access to the mobile device 111 (e.g., the mobile device 111 may be lost, malfunctioned, or fully discharged). The user may press an escape button in the proxy device 109 to trigger the escape routine, and the escape routine may cause the proxy device 109 to send an escape code to the vehicle 101. The escape routine may be triggered for one session and may be repeated each time the escape button is pressed. The escape code may indicate that the user intends to drive the vehicle 101 without pairing the proxy device 109 with the mobile device 111.

Responsive to receiving the escape code, the vehicle 101 may detect occurrence of an escape event. The escape event may describe that the user operates the vehicle 101 without pairing the proxy device 109 with the mobile device 111. The vehicle 101 may activate one or more vehicle functions in response to receiving the escape code so that the user may operate the vehicle 101. For example, even if the proxy device 109 is not paired with the mobile device 111, the escape code may enable the user to use the proxy device 109 (e.g., a keyless entry key fob) to unlock a door and to start ignition of the vehicle 101.

The vehicle 101 may notify another user of the escape event if network connectivity is available. For example, the vehicle 101 may generate a notification that describes a teenager driver drives the vehicle 101 without pairing the proxy device 109 with the mobile device 111. The notification may include a short messaging service (SMS) message, a voice message, an email, or another type of notification. The vehicle 101 may send the notification to the client device 121 associated with a parent of the teenager driver. The vehicle 101 may also provide location updates and/or speed updates associated with the vehicle 101 to the client device 121 in real time or near real time.

However, if network connectivity is not available for the vehicle 101, the vehicle 101 may store the escape event, the notification, the location updates, the speed updates, and/or any other vehicle data on the storage medium 105 of the vehicle 101. Another user (e.g., a parent) may access the stored data at a later time when a connection between the client device 121 and the vehicle 101 is established.

The proxy device 109 may include a proxy communication interface 110. The proxy communication interface 110 may provide any suitable form of communication capability between the proxy device 109 and one or more of the vehicle 101 and the mobile device 111. For example, the proxy communication interface 110 may include a Wi-Fi card for providing Wi-Fi connectivity. By way of example and not limitation, the proxy communication interface 110 may be configured to provide, via wireless mechanisms, LAN connectivity, Bluetooth connectivity, Wi-Fi connectivity, NFC connectivity, M2M connectivity, D2D connectivity, any other suitable communication capability, or any suitable combination thereof. In these and other embodiments, the proxy communication interface 110 may provide direct connectivity between the proxy device 109 and one or more of the vehicle 101 and the mobile device 111.

In some embodiments, the proxy communication interface 110 may include a transmitter and/or a receiver for providing any suitable form of communication capability described herein. For example, the proxy communication interface 110 may receive a secret code from the mobile device 111 and may send the secret code to the vehicle 101. In another example, the proxy communication interface 110 may send a sound alarm code or an escape code from the proxy device 109 to the vehicle 101.

The client device 121 may include a computing device that includes a memory and a processor, for example, a laptop computer, a desktop computer, a tablet computer, a mobile telephone, a PDA, a mobile e-mail device, a portable game player, a portable music player, a television with one or more processors embedded therein or coupled thereto, or another electronic device capable of accessing the network 109. In some embodiments, the vehicle 101 may be operated by a first user (e.g., a teenager with a driver license), and vehicle data that describes how and where the first user drove the vehicle 101 may be stored on the storage medium 105 of the vehicle 101 and/or the server 123. A second user (e.g., a parent of the teenager) may use the client device 121 to access the vehicle data stored on the storage medium 105 and/or the server 123 via the network 109. Alternatively or additionally, the vehicle data may be transmitted to the client device 121 in real time or near real time if the vehicle 101 has access to the network 109.

The server 123 may include a hardware server that includes a processor, a memory, and network communication capabilities. In some embodiments, the server 123 may receive vehicle data from the vehicle 101 and may store the vehicle data on a storage device associated with the server 123. The server 123 may allow users to access the vehicle data via the network 109 using the vehicle 101, the mobile device 111, and/or the client device 121.

The server 123 may include a storage medium 135. Similar to the storage medium 105 of the vehicle 101, the storage medium 135 may include volatile memory such as RAM, persistent or non-volatile storage including, but not limited to, ROM, EEPROM, CD-ROM or other optical disk storage, magnetic disk storage or other magnetic storage device, NAND flash memory or other solid state storage device, or other persistent or non-volatile computer storage medium. The storage medium 135 may store computer instructions that may be executed by a processor of the server 123 to perform one or more of the operations described herein with respect to the server 123.

In some embodiments, the storage medium 135 may store driving data 116b and vehicle data 107b. The driving data 116b may include data that describes one or more driving behaviors of one or more users associated with one or more vehicles 101. The vehicle data 107b may include journey data that describes journeys associated with one or more vehicles 101. Alternatively or additionally, the vehicle data 107b may include data that describes how drivers drive the vehicles 101. In these and other embodiments, the vehicle data 107b may include any other data related to the driving of the vehicles 101.

In some embodiments, the server 123 may process the vehicle data 107a and the driving data 116b in near real time to generate user notifications, vehicle signals, driving scores, and other parameters. The user notifications may include pro-active recommendations and/or other notifications for users of the vehicles 101. The vehicle signals may include signals for enabling or disabling vehicle functionality and/or other signals for controlling the vehicles 101.

The vehicle 101, the proxy device 109, and the mobile device 111 may form a trust network. In some embodiments, the mobile device 111 may be paired with the proxy device 109, and the proxy device 109 may exchange tokens (e.g., the secret code, the escape code, or any other code) with the vehicle 101. Alternatively, both the mobile device 111 and the proxy device 109 may pair with the vehicle 101 and exchange tokens with the vehicle 101, respectively. For example, the mobile device 111 and the proxy device 109 may be coupled to the vehicle 101, respectively. The mobile device 111 may not be directly coupled to the proxy device 109. The mobile device 111 and the proxy device 109 may communicate with each other via the vehicle 101. The proxy device 109 may pair with the vehicle 101 for exchanging first tokens (e.g., the secret code, the escape code, or any other code) with the vehicle 101. The mobile device 111 may also pair with the vehicle 101 for exchanging second tokens with the vehicle 101. The vehicle 101 may determine that the proxy device 109 and the mobile device 111 are associated with the same user or different users based on the exchanged first tokens and second tokens. The vehicle 101 may identify a user identity associated with the mobile device 111 and/or the proxy device 109. The vehicle 101 may activate one or more vehicle functions and/or perform one or more safety control procedures based on the identification of the user identity.

In some embodiments, the vehicle 101 may fail to identify a user identity associated with a user of the mobile device 111 and/or the proxy device 109. For example, the vehicle's confidence in the user's asserted identity is lower than a threshold. The vehicle 101 may prompt the user to enter a personal code from a user interface either on the vehicle 101 or the mobile device 111 so that the vehicle 101 may identify the user based on the personal code. If the vehicle 101 fails to identify the user, the vehicle 101 may notify an owner of the vehicle 101 that the user identity of the user cannot be identified. The vehicle 101 may treat the user as a guest (e.g., a valet or any other guest user of the vehicle 101).

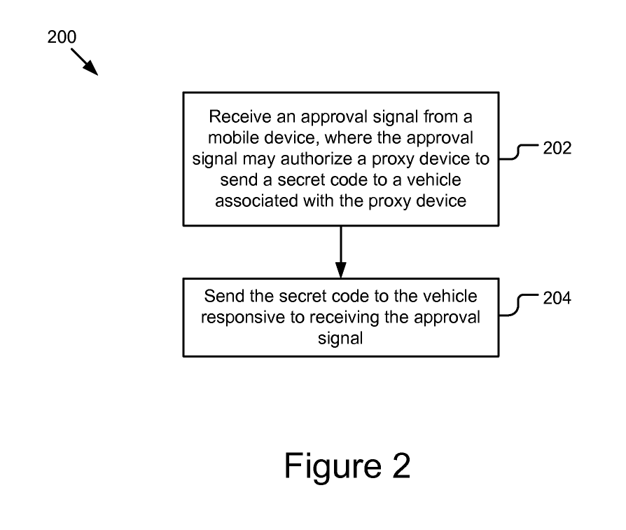

FIG. 2 shows an example flow diagram of a method 200 of communicating a secret code from the proxy device 109 to the vehicle 101, arranged in accordance with at least some embodiments described herein. The method 200 may be performed in whole or in part by, e.g., the proxy device 109 of FIG. 1. Although illustrated as discrete blocks, various blocks may be divided into additional blocks, combined into fewer blocks, or eliminated, depending on the desired implementation.

The method 200 may begin at block 202 in which an approval signal may be received from the mobile device 111. In some embodiments, a user associated with the proxy device 109 may pair the proxy device 109 with the mobile device 111. For example, the user may launch the control application 119 on the mobile device 111 and may use the control application 119 to pair the proxy device 109 with the mobile device 111. The mobile device 111 may generate the approval signal and may send the approval signal to the proxy device 109 responsive to detecting that the proxy device 109 is paired with the mobile device 111. The approval signal may authorize the proxy device 109 to send a secret code to the vehicle 101 so that the vehicle 101 may use the secret code to activate one or more vehicle functions for the user.

For example, the approval signal may enable a keyless entry key fob associated with the vehicle 101 to function as a normal key so that the keyless entry key fob may send a secret code to the vehicle 101. The user may use the keyless entry key fob to unlock the vehicle 101 and to start ignition of the vehicle 101. However, without receiving the approval signal from the mobile device 111, the keyless entry key fob may fail to unlock the door and/or may fail to start ignition of the vehicle 101 in some embodiments. As a result, the user may not be allowed to drive the vehicle 101 if the keyless entry key fob is not paired with the mobile device 111.

At block 204, the secret code may be sent to the vehicle 101 responsive to receiving the approval signal from the mobile device 111.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

Some embodiments disclosed herein include an article of manufacture such as a non-transitory computer storage medium having instructions stored thereon that are executable by a computing device to perform or control performance of operations included in the method 200 of FIG. 2, such as the operations illustrated by blocks 202 and/or 204 in FIG. 2, and/or variations thereof. The non-transitory computer storage medium may be included in or may be accessible to the proxy device 109 of FIG. 1. The computing device may include the proxy device 109.

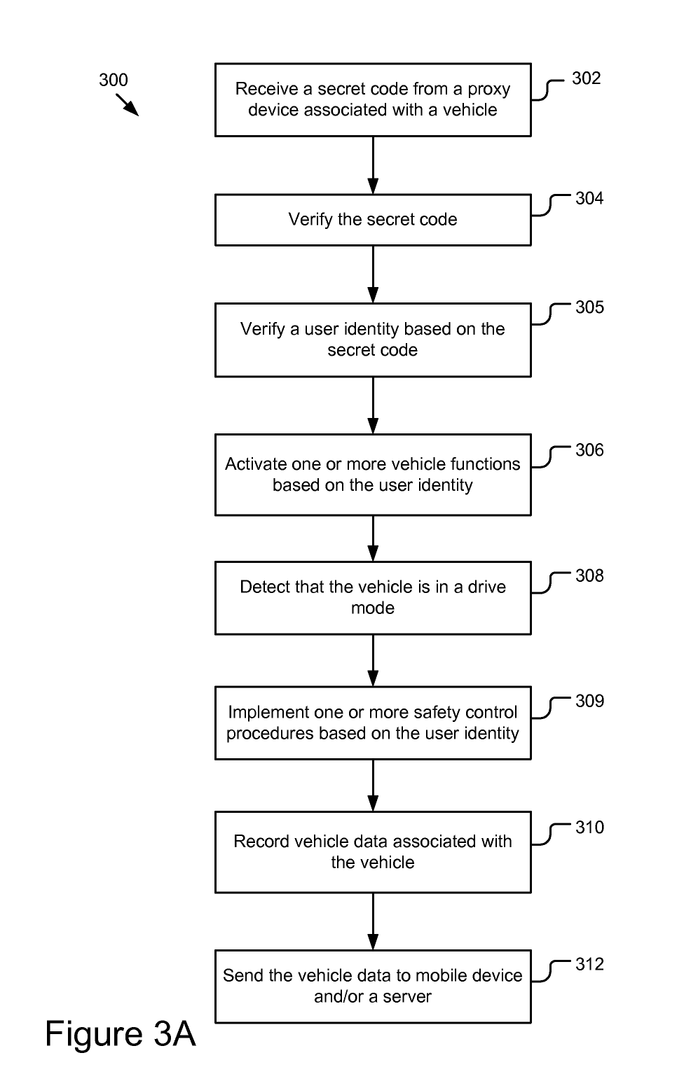

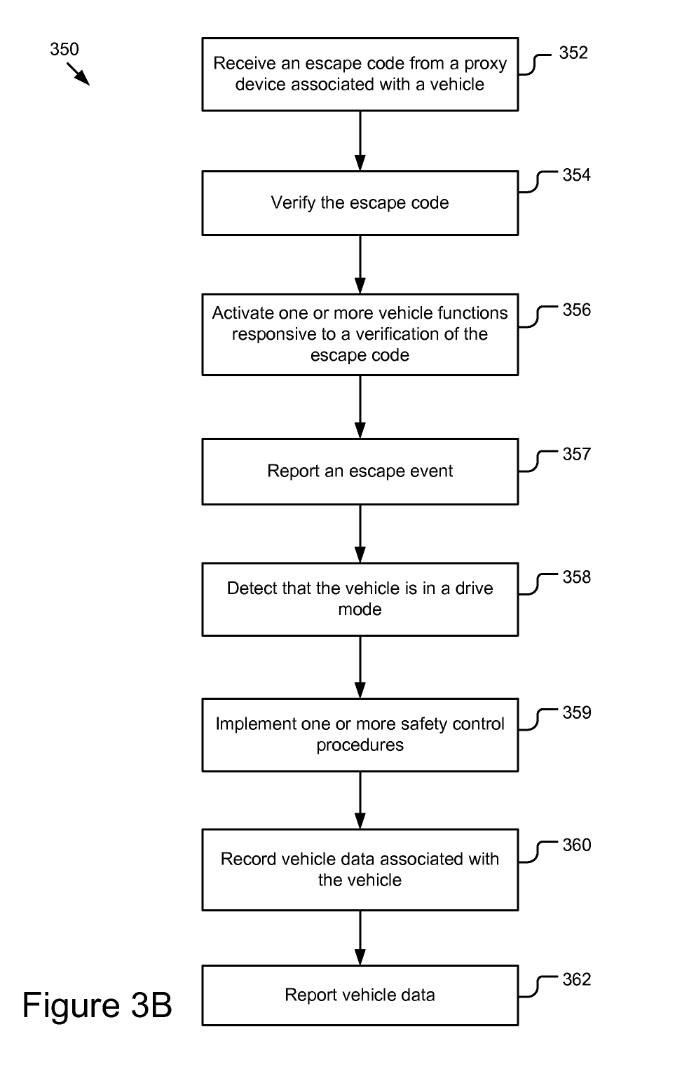

FIG. 3A shows an example flow diagram of a method 300 of implementing one or more vehicle functions and safety control procedures in the vehicle 101 responsive to receiving a secret code from the proxy device 109, arranged in accordance with at least some embodiments described herein. The method 300 may be performed in whole or in part by, e.g., the vehicle 101 of FIG. 1. For convenience in the discussion that follows, the method 300 will be described as being performed on the vehicle 101. Although illustrated as discrete blocks, various blocks may be divided into additional blocks, combined into fewer blocks, or eliminated, depending on the desired implementation.

The method 300 may begin at block 302 in which a secret code may be received from the proxy device 109 associated with the vehicle 101. The secret code may be used to identify a user associated with the proxy device 109.

At block 304, the secret code may be verified. For example, the method 300 may include determining whether the secret code matches a corresponding code stored in the storage medium 105 of the vehicle 101. If the secret code matches the corresponding code, the secret code is verified. The method 300 may include determining a user identifier (ID) that identifies the user associated with the proxy device 109.

At block 305, a user identity associated with a user that operates the proxy device 109 and/or the mobile device 111 may be verified. For example, the user identity may be verified based on the secret code. In another example, the user may enter a personal code via a user interface on the vehicle 101 or the mobile device 111, and the user identity may be verified based on the personal code. In yet another example, the user may be identified as a teenager driver, an owner of the vehicle 101 (e.g., a parent of a teenager), a valet driver, or any other guest driver.

At block 306, one or more vehicle functions may be activated based on the verified user identity. Depending on the user identity, different vehicle functions may be activated for the user. For example, different users may have different settings for the vehicle functions, and the method 300 may activate different vehicle functions for the user based on the user identity. As described below, different driving control policies or privileges may also be implemented based on the user identity.

In some embodiments, the one or more vehicle functions may include unlocking a door of the vehicle 101, starting ignition of the vehicle 101, starting an engine or an electric motor of the vehicle 101, and/or other vehicle functions related to the driving of the vehicle 101. In some other embodiments, the activation of the one or more vehicle functions may allow the user to use the proxy device 109 (e.g., a keyless entry key fob) to unlock the door of the vehicle, to start ignition of the vehicle 101, to start the engine or the electric motor of the vehicle, and/or to perform other functions related to the driving of the vehicle 101. In these and other embodiments, the activation of the one or more vehicle functions may allow the user to drive the vehicle 101.

At block 308, the method 300 may include detecting that the vehicle 101 is in a drive mode. For example, after activation of the one or more vehicle functions, the user may start to drive the vehicle 101. In another example, a transmission of the vehicle 101 may be detected as being in Drive, Reverse, or other non-neutral gear which may indicate that the vehicle 101 is in the drive mode. In another example, a speed of the vehicle 101 may be detected to have a non-zero value, which indicates that the vehicle 101 is in the drive mode.

At block 309, one or more safety control procedures may be implemented responsive to detecting that the vehicle 101 is in the drive mode. For example, a geo-fencing function may be activated for the vehicle 101 so that location updates and/or speed updates of the vehicle 101 may be detected and reported to another user, such as a parent of a teenager driver that drives the vehicle 101. In another example, a speed limit under which the vehicle 101 may be driven on a particular route may be set for the user. In some embodiments, the vehicle 101 may receive one or more control commands from the mobile device 111 and may perform the one or more safety control procedures responsive to receiving the one or more control commands.

In some embodiments, the one or more safety control procedures may be performed based on the verified user identity. For example, different users of the vehicle 101 may be associated with different vehicle capabilities such as speed control, geo-fencing control, and other driving privileges. Different driving policies may also be configured for different users. Depending on an identity of the driver, different safety control procedures may be implemented for the driver. In other words, the implementation of the safety control procedures and enforcement of the driving policies or privileges may be personalized for the driver based on the identity of the driver. For example, a geo-fencing function may be activated for a teenager driver when the teenager driver drives the vehicle 101 and may not be activated for a parent of the teenager when the parent drives the vehicle 101.

At block 310, vehicle data associated with the vehicle 101 may be recorded. For example, the method 300 may include recording one or more of a start point, a destination, a route, a time of departure, a time of arrival, a travel distance, a recorded travel speed, a speed limit, deviations in travel speed above (or below) the speed limit along one or more portions of the route, traffic conditions, road construction information, weather conditions, sudden accelerations, panic braking, and any other data related to the driving of the vehicle 101.

At block 312, the vehicle data may be sent to the mobile device 111 and/or the server 123. In some embodiments, the vehicle data may be used by the mobile device 111 and/or the server 123 to determine a safety score associated with the user. Alternatively or additionally, the vehicle data may be stored in the storage medium 105 of the vehicle 101. Alternatively or additionally, the vehicle data may be sent to the client device 121 in real time or near real time so that another user associated with the client device 121 may know where the vehicle 101 is and how the user drives the vehicle 101 in real time or near real time.

In some embodiments, the method 300 may additionally include providing one or more driving suggestions to the user to improve the user's driving experience and/or driving safety. For example, if the user is driving with a speed over a speed limit on a road, the method 300 may include playing a voice message to advise the user to slow down via a speaker system of the vehicle 101. In another example, the method 300 may include suggesting that the user press a brake pedal slowly to avoid sudden deceleration or that the user press a gas pedal slowly to avoid sudden acceleration.

In some embodiments, the secret code (or the token) may be asserted by the mobile device 111 or the proxy device 109 associated with the user. The secret code (or the token) may be used to establish the user's identity. The method 300 may retrieve data describing the user's driving privileges and/or other associated control policies. The method 300 may enforce the control policies for the user based on the user identity. The method 300 may implement driving controls for the user based on the user's driving privileges and/or other associated control policies.

Some embodiments disclosed herein include an article of manufacture such as a non-transitory computer storage medium having instructions stored thereon that are executable by a computing device to perform operations included in the method 300 of FIG. 3A, such as the operations illustrated by blocks 302, 304, 306, 308, 309, 310, and/or 312 in FIG. 3A, and/or variations thereof. The non-transitory computer storage medium may be included in or may be accessible to the vehicle 101 of FIG. 1, such as the storage medium 105. The computing device may include a processor or other processing device of the vehicle 101, such as the processor 103.

FIG. 3B shows an example flow diagram of a method 350 of implementing one or more vehicle functions and safety control procedures in the vehicle 101 responsive to receiving an escape code from the proxy device 109, arranged in accordance with at least some embodiments described herein. The method 350 may be performed in whole or in part by, e.g., the vehicle 101 of FIG. 1. For convenience in the discussion that follows, the method 350 will be described as being performed on the vehicle 101. Although illustrated as discrete blocks, various blocks may be divided into additional blocks, combined into fewer blocks, or eliminated, depending on the desired implementation.

The method 350 may begin at block 352 in which an escape code may be received from the proxy device 109 associated with the vehicle 101. The escape code may indicate that a user associated with the proxy device 109 may intend to drive the vehicle 101 without pairing the proxy device 109 with the mobile device 111. For example, the mobile device 111 may be lost, malfunctioned, or fully discharged, and it may not be possible for the user to pair the proxy device 109 with the mobile device 111. The user may press an escape button on the proxy device 109, causing the proxy device 109 to send the escape code to the vehicle 101.

At block 354, the escape code may be verified. For example, the method 350 may determine whether the escape code matches a corresponding escape code stored in the storage medium 105 of the vehicle 101. If the escape code received from the proxy device 109 matches the corresponding escape code stored in the storage medium 105, the escape code is verified. A user ID that identifies the user associated with the proxy device 109 may also be determined based on the escape code. For example, the user associated with the proxy device 109 may be identified as a teenager driver.

At block 356, one or more vehicle functions may be activated responsive to a verification of the escape code. In some embodiments, the one or more vehicle functions may include unlocking a door of the vehicle 101, starting ignition of the vehicle 101, starting an engine or an electric motor of the vehicle 101, and/or any other vehicle functions related to the driving of the vehicle 101. Alternatively, the activation of the one or more vehicle functions may allow the user to use the proxy device 109 (e.g., a keyless entry key fob) to unlock the door of the vehicle 101, to start ignition of the vehicle 101, to start the engine or electric motor of the vehicle 101, and/or to perform other vehicle functions related to the driving of the vehicle 101. In these and other embodiments, the activation of the one or more vehicle functions may allow the user to start to drive the vehicle 101.

At block 357, an escape event may be reported to the client device 121 associated with another user. The escape event may indicate that the user drives the vehicle 101 without pairing the proxy device 109 with the mobile device 111. For example, an escape event, which describes a teenager driver drives the vehicle 101 without pairing the proxy device 109 with the mobile device 111, may be sent to the client device 121 associated with a parent of the teenager driver.

At block 358, the method 350 may include detecting that the vehicle 101 is in a drive mode. For example, after activation of the one or more vehicle functions, the user may start to drive the vehicle 101. In another example, a transmission of the vehicle 101 may be detected as being in Drive, Reverse, or other non-neutral gear which may indicate that the vehicle 101 is in the drive mode. As another example, the vehicle 101 is detected to travel with a non-zero speed.

At block 359, one or more safety control procedures may be implemented responsive to detecting the vehicle 101 is in the drive mode. For example, a geo-fencing function may be implemented for the vehicle 101. Alternatively or additionally, a speed limit may be set for the vehicle 101 so that the vehicle 101 may not be operated with a speed over the speed limit. In some embodiments, the safety control procedures may be updated as the vehicle 101 travels a route. For instance, the speed limit set for the vehicle 101 may be updated, e.g., changed up or down, as the vehicle 101 is operated on different roads along the route that have different speed limits.

At block 360, vehicle data associated with the vehicle 101 may be recorded. For example, the method 350 may include recording one or more of a start point, a destination, a route, a time of departure, a time of arrival, a travel distance, a recorded travel speed, a speed limit, deviations in travel speed above (or below) the speed limit along one or more portions of the route, traffic conditions, road construction information, weather conditions, sudden accelerations, panic braking, and/or any other data related to the driving of the vehicle 101.

At block 362, the vehicle data may be reported to the client device 121. For example, vehicle data that describes location updates of the vehicle 101 and how a teenager driver drives the vehicle 101 may be sent to the client device 121 associated with a parent of the teenager driver in real time or near real time. Alternatively or additionally, the vehicle data may be sent to the mobile device 111 and/or the server 123. In some embodiments, the vehicle data may be used by the mobile device 111 and/or the server 123 to determine a safety score associated with the user. Alternatively or additionally, the vehicle data may be stored on the storage medium 105 of the vehicle 101.

Some embodiments disclosed herein include an article of manufacture such as a non-transitory computer storage medium having instructions stored thereon that are executable by a computing device to perform or control performance of operations included in the method 350 of FIG. 3B, such as the operations illustrated by blocks 352, 354, 356, 357, 358, 359, 360, and/or 362 in FIG. 3B, and/or variations thereof. The non-transitory computer storage medium may be included in or may be accessible to the vehicle 101 of FIG. 1, such as the storage medium 105. The computing device may include any of a processor or other processing device of the vehicle 101, such as the processor 103.

FIG. 4 shows an example flow diagram of a method 400 of monitoring and controlling the driving of the vehicle 101, arranged in accordance with at least some embodiments described herein. The method 400 may be performed in whole or in part by, e.g., the mobile device 111 of FIG. 1. For convenience in the discussion that follows, the method 400 will be described as being performed on the mobile device 111 of FIG. 1. Although illustrated as discrete blocks, various blocks may be divided into additional blocks, combined into fewer blocks, or eliminated, depending on the desired implementation.

The method 400 may begin at block 402 in which the mobile device 111 may be detected to be paired with the proxy device 109 associated with the vehicle 101. For example, a user associated with the proxy device 109 may launch the control application 119 on the mobile device 111 and may pair the mobile device 111 with the proxy device 109 using the control application 119. The mobile device 111 may monitor and control the driving of the vehicle 101 after being paired with the proxy device 109.

At block 404, an approval signal may be generated responsive to the mobile device 111 being paired with the proxy device 109. The approval signal may allow the user to use the proxy device 109 to operate the vehicle 101.

At block 406, the approval signal may be sent to the proxy device 109. The approval signal may authorize the proxy device 109 to send a secret code to the vehicle 101 for activating one or more vehicle functions associated with the vehicle 101. For example, the mobile device 111 may send the approval signal to the proxy device 109, causing the proxy device 109 to send the secret code to the vehicle 101 for activating one or more vehicle functions in the vehicle 101.

At block 408, the method 400 may include detecting that the vehicle 101 is in a drive mode responsive to an activation of the one or more vehicle functions. For example, after the activation of the one or more vehicle functions, the user may start to drive the vehicle 101. The mobile device 111 may detect that the vehicle 101 has a non-zero travel speed and may determine that the vehicle 101 is in the drive mode. Alternatively or additionally, the vehicle 101 may send a signal to the mobile device 111 that indicates the vehicle 101 is in the drive mode.

At block 410, one or more driving control functions may be performed responsive to detecting that the vehicle 101 is in the drive mode. In some embodiments, one or more first control commands may be generated and sent to the mobile device 111. The one or more first control commands may be configured to restrict usage of one or more device functions on the mobile device 111. For example, the one or more first control commands may be configured to restrict a texting function, a phone calling function, a usage of one or more applications, and any other device functions that may distract the user from the driving task. Generally, the user may not be allowed to use the mobile device 111 to perform the one or more device functions during driving; however, the user may use the mobile device 111 to place a phone call, to send a text message, and/or to perform other device functions in an emergency situation.

Alternatively or additionally, one or more second control commands may be generated and sent to the vehicle 101. The one or more second control commands may be configured to activate an implementation of one or more safety control procedures. For example, the one or more second control commands may instruct the vehicle 101 to perform a geo-fencing function, to set a speed limit under which the vehicle 101 may travel on a road, to perform a blood alcohol content test, and/or to perform any other control procedures to improve driving safety.

In some embodiments, the method 400 may additionally include receiving vehicle data from the vehicle 101. The method 400 may include determining a safety score for the user based on the vehicle data. For example, the method 400 may determine a safety score based on a recorded speed of the vehicle 101 on a road, a speed limit on the road, weather conditions on the road, traffic conditions on the road, sudden accelerations, panic braking, and/or other data that may be used to infer safe or unsafe driving behaviors. The method 400 may include sending the safety score to a client device associated with another user that is interested in learning the safety score of the user. For example, the method 400 may send a safety score associated with a teenager driver to a client device associated with a parent of the teenager driver.

The method 400 may additionally include generating notifications based on the vehicle data in real time or near real time. The notifications may describe location updates of the vehicle 101 and/or how the user drives the vehicle 101. The notifications may be sent to the client device 121 so that another user associated with the client device 121 may learn location updates, speed updates, and other vehicle data associated with the vehicle 101 in real time or near real time.

The method 400 may additionally include providing one or more driving suggestions to the user to improve the user's driving experience and/or driving safety.

Some embodiments disclosed herein include an article of manufacture such as a non-transitory computer storage medium having instructions stored thereon that are executable by a computing device to perform operations included in the method 400 of FIG. 4, such as the operations illustrated by blocks 402, 404, 406, 408, and/or 410 in FIG. 4, and/or variations thereof. The non-transitory computer storage medium may be included in or may be accessible to the mobile device 111 of FIG. 1, such as the storage medium 115. The computing device may include the mobile device 111, and/or a processor or other processing device of the mobile device 111, such as the processor 113.

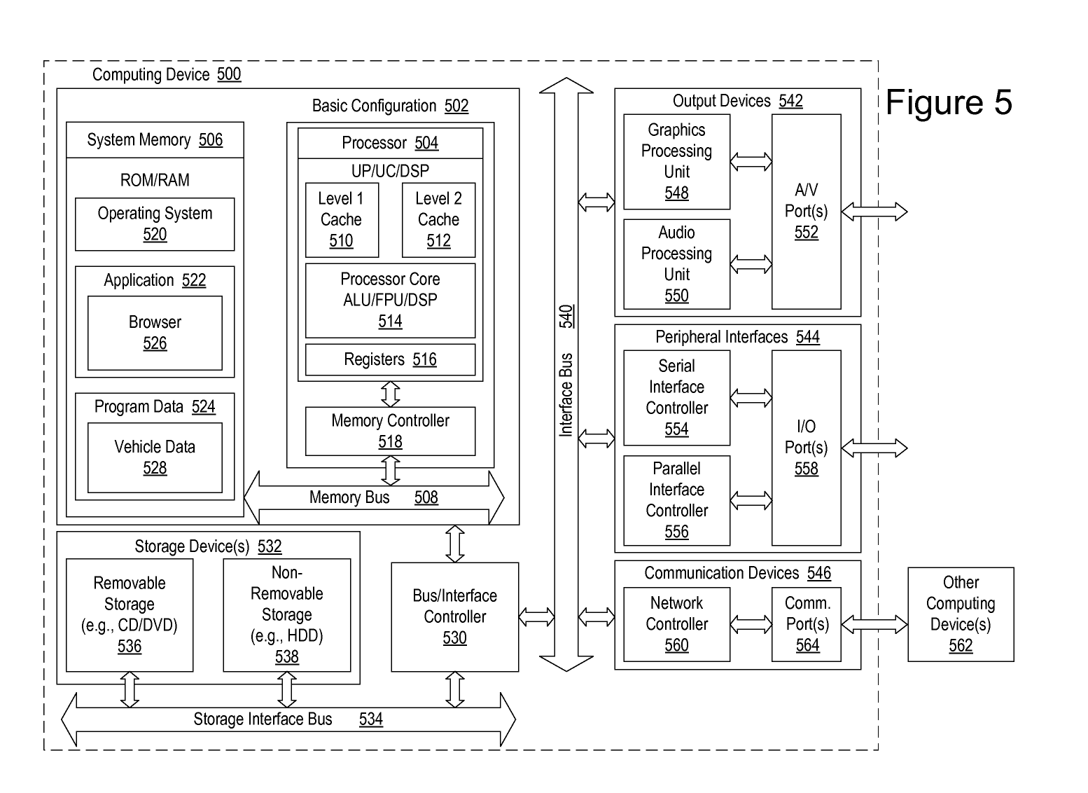

FIG. 5 is a block diagram illustrating an example computing device 500 that is arranged for monitoring and controlling vehicle driving, in accordance with at least some embodiments described herein. The computing device 500 may be included in or correspond to any of the proxy device 109, the mobile device 111, the client device 121, and/or the vehicle 101 of FIG. 1, for example. In a very basic configuration 502, the computing device 500 may typically include one or more processors 504 and a system memory 506. A memory bus 508 may be used for communicating between the processor 504 and the system memory 506.

Depending on the desired configuration, the processor 504 may be of any type including, but not limited to, a CPU, a μP, a μC, a DSP, or any combination thereof. The processor 504 may include one or more levels of caching, such as a level one cache 510 and a level two cache 512, a processor core 514, and registers 516. The example processor core 514 may include an arithmetic logic unit (ALU), a floating point unit (FPU), a digital signal processing core (DSP core), or any combination thereof. An example memory controller 518 may also be used with the processor 504, or in some implementations the memory controller 518 may be an internal part of the processor 504.

Depending on the desired configuration, the system memory 506 may be of any type including, but not limited to, volatile memory (such as RAM), non-volatile memory (such as ROM, flash memory), or any combination thereof. The system memory 506 may include an operating system (OS) 520, one or more applications 522, and program data 524. The application 522 may include a browser 526, an app, an application server, or other application that may be arranged to perform one or more of the functions as described herein including those described with respect to the methods 200, 300, 350, and/or 400 of FIGS. 2-4. The program data 524 may include vehicle data 528 that may be pulled into the application 522 for analysis on one of the mobile device 111, the vehicle 101, and the client device 121 of FIG. 1, for example. In some embodiments, the application 522 may be arranged to operate with the program data 524 on the OS 520 such that implementations of methods for communicating a secret code from the proxy device 109 to the vehicle 101, implementing one or more vehicle functions and safety control procedures, and/or monitoring and controlling vehicle driving, such as the methods 200, 300, 350, and 400 of FIGS. 2-4, may be provided as described herein.

The computing device 500 may have additional features or functionality, and additional interfaces to facilitate communications between the basic configuration 502 and any required devices and interfaces. For example, a bus/interface controller 530 may be used to facilitate communications between the basic configuration 502 and one or more data storage devices 532 via a storage interface bus 534. The data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer-readable instructions, data structures, program modules, or other data.

The system memory 506, removable storage devices 536, and non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (e.g., output devices 542, peripheral interfaces 544, and communication devices 546) to the basic configuration 502 via the bus/interface controller 530. Example output devices 542 include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device) or other peripheral devices (e.g., printer, scanner) via one or more I/O ports 558. The example communication device 546 may include a network controller 560, which may be arranged to facilitate communications with one or more other computing devices 562 over a network communication link via one or more communication ports 564.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media as used herein may include both storage media and communication media.

The computing device 500 may be implemented as a portion of a small-form factor portable (or mobile) electronic device such as a cell phone, a personal data assistant (PDA), a personal media player device, a wireless web-watch device, a personal headset device, an application-specific device, or a hybrid device that includes any of the above functions. The computing device 500 may also be implemented as a personal computer including both laptop computer and non-laptop computer configurations.

The present disclosure is not to be limited in terms of the particular embodiments described herein, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that the present disclosure is not limited to particular methods, reagents, compounds, compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of controlling vehicle driving, the method comprising:
detecting that a mobile device is paired with a proxy device associated with a vehicle;
generating an approval signal responsive to detecting that the mobile device is paired with the proxy device;
sending the approval signal to the proxy device, wherein the approval signal authorizes the proxy device to send a secret code to the vehicle to activate one or more vehicle functions associated with the vehicle;
detecting that the vehicle is in a drive mode responsive to an activation of the one or more vehicle functions; and
performing one or more driving control functions responsive to detecting that the vehicle is in the drive mode.

2. The method of claim 1, wherein the one or more vehicle functions include one or more of unlocking a door of the vehicle, activating ignition of the vehicle, and starting the vehicle.

3. The method of claim 1, wherein the proxy device includes one of a keyless entry key fob, another mobile device, and a smart wearable device.

4. The method of claim 1, wherein performing the one or more driving control functions comprises:
sending one or more first control commands to the mobile device, wherein the one or more first control commands are configured to restrict one or more device functions on the mobile device; and
sending one or more second control commands to the vehicle, wherein the one or more second control commands are configured to activate an implementation of one or more safety control procedures.

5. The method of claim 4, wherein:
the one or more device functions include one or more of a texting function, a phone calling function, and a usage of an application on the mobile device; and
the implementation of the one or more safety control procedures includes one or more of performing a geo-fencing function, setting a speed limit for the vehicle, and performing a blood alcohol content test.

6. The method of claim 1, further comprising:
receiving vehicle data from the vehicle; and
determining a safety score based on the vehicle data.

7. The method of claim 1, further comprising:
receiving vehicle data from the vehicle;
generating a notification based on the vehicle data; and
sending the notification to a client device.

8. An article of manufacture comprising a non-transitory computer storage medium having computer instructions stored thereon that are executable by a computing device to perform operations comprising:
detecting that a mobile device is paired with a proxy device associated with a vehicle;
generating an approval signal responsive to detecting that the mobile device is paired with the proxy device;
sending the approval signal to the proxy device, wherein the approval signal authorizes the proxy device to send a secret code to the vehicle to activate one or more vehicle functions associated with the vehicle;
detecting that the vehicle is in a drive mode responsive to an activation of the one or more vehicle functions; and
performing one or more driving control functions responsive to detecting that the vehicle is in the drive mode.

9. The article of manufacture of claim 8, wherein the one or more vehicle functions include one or more of unlocking a door of the vehicle, activating ignition of the vehicle, and starting the vehicle.

10. The article of manufacture of claim 8, wherein the proxy device includes one of a keyless entry key fob, another mobile device, and a smart wearable device.

11. The article of manufacture of claim 8, wherein performing the one or more driving control functions comprises:
sending one or more first control commands to the mobile device, wherein the one or more first control commands are configured to restrict one or more device functions on the mobile device; and
sending one or more second control commands to the vehicle, wherein the one or more second control commands are configured to activate an implementation of one or more safety control procedures.

12. The article of manufacture of claim 11, wherein:
the one or more device functions include one or more of a texting function, a phone calling function, and a usage of an application on the mobile device; and
the implementation of the one or more safety control procedures includes one or more of performing a geo-fencing function, setting a speed limit for the vehicle, and performing a blood alcohol content test.

13. The article of manufacture of claim 8, wherein the operations further comprise:
receiving vehicle data from the vehicle; and
determining a safety score based on the vehicle data.

14. The article of manufacture of claim 8, wherein the operations further comprise:
receiving vehicle data from the vehicle;
generating a notification based on the vehicle data; and
sending the notification to a client device.

15. A system of controlling vehicle driving, the system comprising:
a processor; and
a memory storing instructions that, in response to execution by the processor, cause the processor to:
detect that a mobile device is paired with a proxy device associated with a vehicle;
generate an approval signal responsive to detecting that the mobile device is paired with the proxy device;
send the approval signal to the proxy device, wherein the approval signal authorizes the proxy device to send a secret code to the vehicle to activate one or more vehicle functions associated with the vehicle;
detect that the vehicle is in a drive mode responsive to an activation of the one or more vehicle functions; and
perform one or more driving control functions responsive to detecting that the vehicle is in the drive mode.

16. The system of claim 15, wherein the one or more vehicle functions include one or more of unlocking a door of the vehicle, activating ignition of the vehicle, and starting the vehicle.

17. The system of claim 15, wherein the proxy device includes one of a keyless entry key fob, another mobile device, and a smart wearable device.

18. The system of claim 15, wherein the instructions, in response to execution by the processor, cause the processor to perform the one or more driving control functions by:
sending one or more first control commands to the mobile device, wherein the one or more first control commands are configured to restrict one or more device functions on the mobile device; and
sending one or more second control commands to the vehicle, wherein the one or more second control commands are configured to activate an implementation of one or more safety control procedures.

19. The system of claim 18, wherein:
the one or more device functions include one or more of a texting function, a phone calling function, and a usage of an application on the mobile device; and
the implementation of the one or more safety control procedures includes one or more of performing a geo-fencing function, setting a speed limit for the vehicle, and performing a blood alcohol content test.

20. The system of claim 15, wherein the instructions, in response to execution by the processor, further cause the system to:
receive vehicle data from the vehicle; and
determine a safety score based on the vehicle data.
